(19) United States
(12) Patent Application Publication
(10) Pub. No.: US 2026/0172592 A1
(43) Pub. Date: Jun. 18, 2026

(54) MOTION VECTOR REFINEMENT FOR GEOMETRIC PARTITIONING FOR MOTION PREDICTION

(71) Applicant: Alibaba (China) Co., Ltd., Hangzhou (CN)

(72) Inventors: Yuqing YANG, Beijing (CN); Jiaxu ZHANG, Beijing (CN); Jie Chen, Beijing (CN); Xinwei Li, Beijing (CN); Ru-ling Liao, Sunnyvale, CA (US); Yan Ye, San Diego, CA (US)

(21) Appl. No.: 19/395,963

(22) Filed: Nov. 20, 2025

Related U.S. Application Data
(60) Provisional application No. 63/735,777, filed on Dec. 18, 2024.

(51) Int. Cl. H04N 19/52; H04N 19/105; H04N 19/176

(52) U.S. Cl. CPC H04N 19/52; H04N 19/105; H04N 19/176

(57) ABSTRACT

A VVC and later standard encoder and a VVC and later standard decoder are provided, configuring one or more processors of a computing system to perform motion vector refinement for geometric partitioning for motion prediction, and more specifically application of first-pass and second-pass Decoder-side Motion Vector Refinement (“DMVR”) in GPM motion prediction. The VVC and later standard encoder and decoder implement performing motion prediction upon two partitions of a geometric partitioning mode (GPM)-coded coding block, based on respective motion information of each partition, and applying weighted blending to respective motion predictions of each partition of the GPM-coded coding block based on a blending matrix, wherein the blending matrix depends on a split mode.

### RELATED APPLICATIONS

This application claims the benefit of U.S. Patent Application No. 63/735,777, entitled “MOTION VECTOR REFINEMENT FOR GEOMETRIC PARTITIONING FOR MOTION PREDICTION” and filed Dec. 18, 2024, which is expressly incorporated herein by reference in its entirety.

### BACKGROUND

In 2020, the Joint Video Experts Team (“JVET”) of the ITU-T Video Coding Expert Group (“ITU-T VCEG”) and the ISO/IEC Moving Picture Expert Group (“ISO/IEC MPEG”) published the final draft of the next-generation video codec specification, Versatile Video Coding (“VVC”). This specification further improves video coding performance over prior standards such as H.264/AVC (Advanced Video Coding) and H.265/HEVC (High Efficiency Video Coding). The JVET developed further techniques beyond the scope of the VVC standard under the Enhanced Compression Model (“ECM”) name, which has formed the basis for the successor H.267 standard currently in draft status.

According to VVC and later standards, an encoder and a decoder partition picture data into blocks, and perform motion prediction upon luma and chroma components of the blocks by selecting one among various intra prediction and inter prediction modes. VVC and later standards provide Geometric Partitioning Mode (“GPM”), where, to efficiently code boundaries and edges of objects in a picture, any particular block of a picture can be internally partitioned into two irregular partitions by a partitioning line spanning two edges of the block. GPM provides for predefined sets of unique internal partitioning modes of blocks and sub-blocks of various dimensions, enabling boundaries and edges in a picture to be described accurately in a granular manner.

Moreover, at time of writing, the latest draft of ECM (presented at the 40th meeting of the JVET in October 2025 as “Algorithm description of Enhanced Compression Model 19 (ECM 19)”) extends GPM.

Decoder-side Motion Vector Refinement (“DMVR”), including multi-pass DMVR and adaptive DMVR, is a coding tool to refine the MV at decoder-side without additional signaling, as the MV inheriting from the neighboring block may not perfectly match with the current block. Affine motion compensation may be used to capture the affine motion between two different frames.

There is a need to further improve the implementation of motion vector refinement in VVC and later standards as extended by ECM.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIGS. 1A and 1B illustrate example block diagrams of, respectively, a video encoding process and a video decoding process according to example embodiments of the present disclosure.

FIG. 2 illustrates classifications of geometric partitioning mode (“GPM”) coded coding units (“CUs”) by their respective angles.

FIG. 3 illustrates an example blending weight w₀ derived for position (x, y).

FIG. 4 illustrates ramp functions for additional adoptive blending area widths based on the ramp function of an original blending area width.

FIG. 5 illustrates an example of extending a partition splitting line of a current CU.

FIGS. 6A through 6C illustrate respective examples of the available IPM candidates.

FIG. 6D illustrates GPM with intra and intra prediction.

FIG. 7 illustrates a diagram of bilateral matching costs used in a second pass of a multi-pass decoder-side motion vector refinement.

FIG. 8 illustrates a flowchart of a GPM motion prediction process according to VVC and later standards extended by ECM.

FIG. 9 illustrates a flowchart of a motion vector refinement process for GPM motion prediction according to example embodiments of the present disclosure.

FIG. 10 illustrates a diagram of motion prediction performed upon a current picture according to bi-prediction, wherein offset blocks of reference pictures are used to calculate a refined motion vector that is in turn used to generate a bi-predicted signal.

FIG. 11 illustrates a flowchart of motion vector refinement for GPM motion prediction according to example embodiments of the present disclosure.

FIG. 12 illustrates a flowchart of motion vector refinement for GPM motion prediction according to example embodiments of the present disclosure.

FIG. 13 illustrates an example system for implementing the processes and methods described herein for implementing spatial geometric partitioning.

### DETAILED DESCRIPTION

Systems and methods discussed herein are directed to implementing motion vector refinement for geometric partitioning for motion prediction, and more specifically application of first-pass and second-pass Decoder-side Motion Vector Refinement (“DMVR”) in GPM motion prediction.

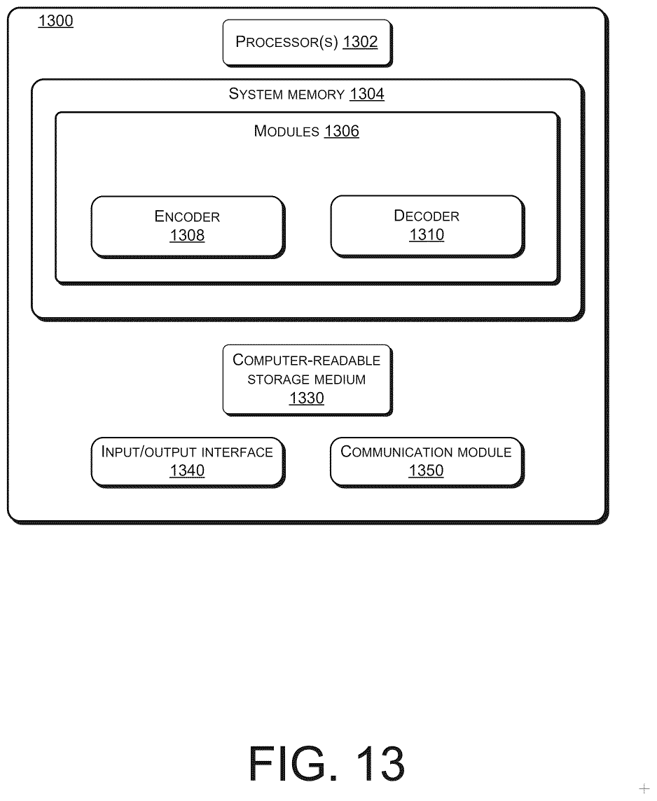

In accordance with the H.264/AVC (Advanced Video Coding), H.265/HEVC (High Efficiency Video Coding), Versatile Video Coding (“VVC”) standards, and successor standards currently in draft status such as H.267, a computing system includes at least one or more processors and a computer-readable storage medium communicatively coupled to the one or more processors. The computer-readable storage medium is a non-transient or non-transitory computer-readable storage medium, as defined subsequently with reference to FIG. 13, storing computer-readable instructions. At least some computer-readable instructions stored on a computer-readable storage medium are executable by one or more processors of a computing system to configure the one or more processors to perform associated operations of the computer-readable instructions, including at least operations of an encoder as described by VVC and later standards, and operations of a decoder as described by VVC and later standards. Some of these encoder operations and decoder operations according to VVC and later standards are subsequently described in further detail, though these subsequent descriptions should not be understood as exhaustive of encoder operations and decoder operations according to VVC and later standards. Subsequently, a “VVC and later standard encoder” and a “VVC and later standard decoder” shall describe the respective computer-readable instructions stored on a computer-readable storage medium which configure one or more processors to perform these respective operations (which can be called, by way of example, “reference implementations” of an encoder or a decoder).

Moreover, according to example embodiments of the present disclosure, a VVC and later standard encoder and a VVC and later standard decoder further include computer-readable instructions stored on a computer-readable storage medium which are executable by one or more processors of a computing system to configure the one or more processors to perform operations not specified by VVC and later standards. A VVC and later standard encoder should not be understood as limited to operations of a reference implementation of an encoder, but including further computer-readable instructions configuring one or more processors of a computing system to perform further operations as described herein. A VVC and later standard decoder should not be understood as limited to operations of a reference implementation of a decoder, but including further computer-readable instructions configuring one or more processors of a computing system to perform further operations as described herein.

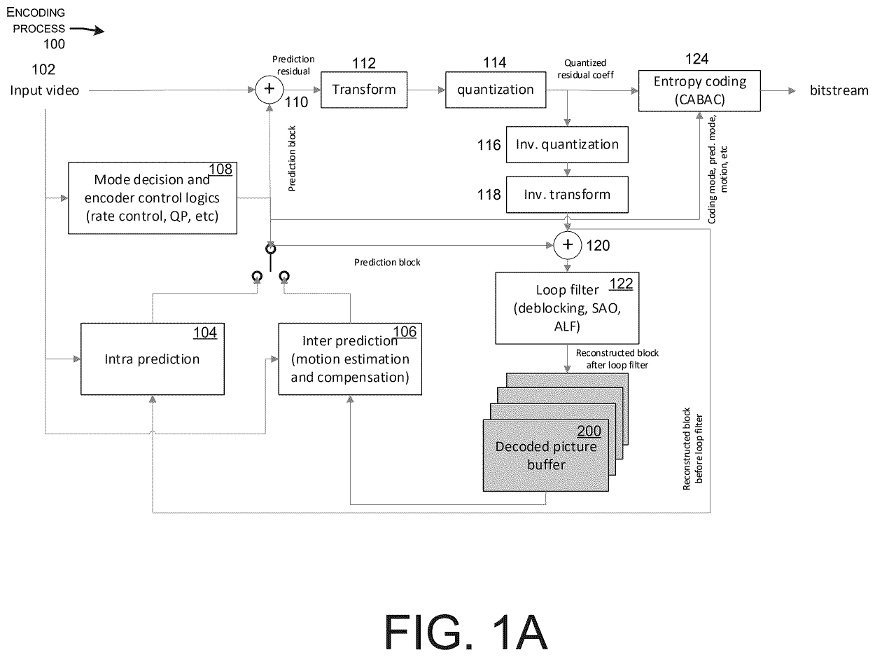

FIGS. 1A and 1B illustrate example block diagrams of respectively, an encoding process 100 and a decoding process 150 according to an example embodiment of the present disclosure.

In an encoding process 100, a VVC and later standard encoder configures one or more processors of a computing system to receive, as input, one or more input pictures from an image source 102. An input picture includes some number of pixels sampled by an image capture device, such as a photosensor array, and includes an uncompressed stream of multiple color channels (such as RGB color channels) storing color data at an original resolution of the picture, where each channel stores color data of each pixel of a picture using some number of bits. A VVC and later standard encoder configures one or more processors of a computing system to store this uncompressed color data in a compressed format, wherein color data is stored at a lower resolution than the original resolution of the picture, encoded as a luma (“Y”) channel and two chroma (“U” and “V”) channels of lower resolution than the luma channel.

A VVC and later standard encoder encodes a picture (a picture being encoded being called a “current picture,” as distinguished from any other picture received from an image source 102) by configuring one or more processors of a computing system to partition the original picture into units and subunits according to a partitioning structure. A VVC and later standard encoder configures one or more processors of a computing system to subdivide a picture into macroblocks (“MBs”) each having dimensions of 16×16 pixels, which can be further subdivided into partitions. A VVC and later standard encoder configures one or more processors of a computing system to subdivide a picture into coding tree units (“CTUs”), the luma and chroma components of which can be further subdivided into coding tree blocks (“CTBs”) which are further subdivided into coding units (“CUs”). Alternatively, a VVC and later standard encoder configures one or more processors of a computing system subdivide a picture into units of N×N pixels, which can then be further subdivided into subunits. Each of these largest subdivided units of a picture can generally be referred to as a “block” for the purpose of this disclosure.

A CU is coded using one block of luma samples and two corresponding blocks of chroma samples, where pictures are not monochrome and are coded using one coding tree.

A VVC and later standard encoder configures one or more processors of a computing system to subdivide a block into partitions having dimensions in multiples of 4×4 pixels. For example, a partition of a block can have dimensions of 8×4 pixels, 4×8 pixels, 8×8 pixels, 16×8 pixels, or 8×16 pixels.

By encoding color information of blocks of a picture and subdivisions thereof, rather than color information of pixels of a full-resolution original picture, a VVC and later standard encoder configures one or more processors of a computing system to encode color information of a picture at a lower resolution than the input picture, storing the color information in fewer bits than the input picture.

Furthermore, a VVC and later standard encoder encodes a picture by configuring one or more processors of a computing system to perform motion prediction upon blocks of a current picture. Motion prediction coding refers to storing image data of a block of a current picture (where the block of the original picture, before coding, is referred to as an “input block”) using motion information and prediction units (“PUs”), rather than pixel data, according to intra prediction 104 or inter prediction 106.

Motion information refers to data describing motion of a block structure of a picture or a unit or subunit thereof, such as motion vectors and references to blocks of a current picture or of a reference picture. PUs can refer to a unit or multiple subunits corresponding to a block structure among multiple block structures of a picture, such as an MB or a CTU, wherein blocks are partitioned based on the picture data and are coded according to VVC and later standards. Motion information corresponding to a PU can describe motion prediction as encoded by a VVC and later standard encoder as described herein.

A VVC and later standard encoder configures one or more processors of a computing system to code motion prediction information over each block of a picture in a coding order among blocks, such as a raster scanning order wherein a first-decoded block is an uppermost and leftmost block of the picture. A block being encoded is called a “current block,” as distinguished from any other block of a same picture.

According to intra prediction 104, one or more processors of a computing system are configured to encode a block by references to motion information and PUs of one or more other blocks of the same picture. According to intra prediction coding, one or more processors of a computing system perform an intra prediction 104 (also called spatial prediction) computation by coding motion information of the current block based on spatially neighboring samples from spatially neighboring blocks of the current block.

According to inter prediction 106, one or more processors of a computing system are configured to encode a block by references to motion information and PUs of one or more other pictures. One or more processors of a computing system are configured to store one or more previously coded and decoded pictures in a reference picture buffer for the purpose of inter prediction coding; these stored pictures are called reference pictures.

One or more processors are configured to perform an inter prediction 106 (also called temporal prediction or motion compensated prediction) computation by coding motion information of the current block based on samples from one or more reference pictures. Inter prediction can further be computed according to uni-prediction or bi-prediction: in uni-prediction, only one motion vector, pointing to one reference picture, is used to generate a prediction signal for the current block. In bi-prediction, two motion vectors, each pointing to a respective reference picture, are used to generate a prediction signal of the current block.

A VVC and later standard encoder configures one or more processors of a computing system to code a CU to include reference indices to identify, for reference of a VVC and later standard decoder, the prediction signal(s) of the current block. One or more processors of a computing system can code a CU to include an inter prediction indicator. An inter prediction indicator indicates list 0 prediction in reference to a first reference picture list referred to as list 0, list 1 prediction in reference to a second reference picture list referred to as list 1, or bi-prediction in reference to both reference picture lists referred to as, respectively, list 0 and list 1.

In the cases of the inter prediction indicator indicating list 0 prediction or list 1 prediction, one or more processors of a computing system are configured to code a CU including a reference index referring to a reference picture of the reference picture buffer referenced by list 0 or by list 1, respectively. In the case of the inter prediction indicator indicating bi-prediction, one or more processors of a computing system are configured to code a CU including a first reference index referring to a first reference picture of the reference picture buffer referenced by list 0, and a second reference index referring to a second reference picture of the reference picture referenced by list 1.

A VVC and later standard encoder configures one or more processors of a computing system to code each current block of a picture individually, outputting a prediction block for each. According to VVC and later standards, a CTU can be as large as 128×128 luma samples (plus the corresponding chroma samples, depending on the chroma format). A CTU can be further partitioned into CUs according to a quad-tree, binary tree, or ternary tree. One or more processors of a computing system are configured to ultimately record coding parameter sets such as coding mode (intra mode or inter mode), motion information (reference index, motion vectors, etc.) for inter-coded blocks, and quantized residual coefficients, at syntax structures of leaf nodes of the partitioning structure.

After a prediction block is output, a VVC and later standard encoder configures one or more processors of a computing system to send coding parameter sets such as coding mode (i.e., intra or inter prediction), a mode of intra prediction or a mode of inter prediction, and motion information to an entropy coder 124 (as described subsequently).

VVC and later standards provide semantics for recording coding parameter sets for a CU. For example, with regard to the above-mentioned coding parameter sets, pred_mode_flag for a CU is set to 0 for an inter-coded block, and is set to 1 for an intra-coded block; general_merge_flag for a CU is set to indicate whether merge mode is used in inter prediction of the CU; inter_affine_flag and cu_affine_type_flag for a CU are set to indicate whether affine motion compensation is used in inter prediction of the CU; mvp_l0_flag and mvp_l1_flag are set to indicate a motion vector index in list 0 or in list 1, respectively; and ref_idx_l0 and ref_idx_l1 are set to indicate a reference picture index in list 0 or in list 1, respectively. It should be understood that VVC and later standards include semantics for recording various other information, flags, and options which are beyond the scope of the present disclosure.

A VVC and later standard encoder further implements one or more mode decision and encoder control settings 108, including rate control settings. One or more processors of a computing system are configured to perform mode decision by, after intra or inter prediction, selecting an optimized prediction mode for the current block, based on the rate-distortion optimization method.

A rate control setting configures one or more processors of a computing system to assign different quantization parameters (“QPs”) to different pictures. Magnitude of a QP determines a scale over which picture information is quantized during encoding by one or more processors (as shall be subsequently described), and thus determines an extent to which the encoding process 100 discards picture information (due to information falling between steps of the scale) from MBs of the sequence during coding.

A VVC and later standard encoder further implements a subtractor 110. One or more processors of a computing system are configured to perform a subtraction operation by computing a difference between an input block and a prediction block. Based on the optimized prediction mode, the prediction block is subtracted from the input block. The difference between the input block and the prediction block is called prediction residual, or “residual” for brevity.

Based on a prediction residual, a VVC and later standard encoder further implements a transform 112. One or more processors of a computing system are configured to perform a transform operation on the residual by a matrix arithmetic operation to compute an array of coefficients (which can be referred to as “residual coefficients,” “transform coefficients,” and the like), thereby encoding a current block as a transform block (“TB”). Transform coefficients can refer to coefficients representing one of several spatial transformations, such as a diagonal flip, a vertical flip, or a rotation, which can be applied to a sub-block.

It should be understood that a coefficient can be stored as two components, an absolute value and a sign, as shall be described in further detail subsequently.

Sub-blocks of CUs, such as PUs and TBs, can be arranged in any combination of sub-block dimensions as described above. A VVC and later standard encoder configures one or more processors of a computing system to subdivide a CU into a residual quadtree (“RQT”), a hierarchical structure of TBs. The RQT provides an order for motion prediction and residual coding over sub-blocks of each level and recursively down each level of the RQT.

A VVC and later standard encoder further implements a quantization 114. One or more processors of a computing system are configured to perform a quantization operation on the residual coefficients by a matrix arithmetic operation, based on a quantization matrix and the QP as assigned above. Residual coefficients falling within an interval are kept, and residual coefficients falling outside the interval step are discarded.

A VVC and later standard encoder further implements an inverse quantization 116 and an inverse transform 118. One or more processors of a computing system are configured to perform an inverse quantization operation and an inverse transform operation on the quantized residual coefficients, by matrix arithmetic operations which are the inverse of the quantization operation and transform operation as described above. The inverse quantization operation and the inverse transform operation yield a reconstructed residual.

A VVC and later standard encoder further implements an adder 120. One or more processors of a computing system are configured to perform an addition operation by adding a prediction block and a reconstructed residual, outputting a reconstructed block.

A VVC and later standard encoder further implements a loop filter 122. One or more processors of a computing system are configured to apply a loop filter, such as a deblocking filter, a sample adaptive offset (“SAO”) filter, and adaptive loop filter (“ALF”) to a reconstructed block, outputting a filtered reconstructed block.

A VVC and later standard encoder further configures one or more processors of a computing system to output a filtered reconstructed block to a decoded picture buffer (“DPB”) 200. A DPB 200 stores reconstructed pictures which are used by one or more processors of a computing system as reference pictures in coding pictures other than the current picture, as described above with reference to inter prediction.

A VVC and later standard encoder further implements an entropy coder 124. One or more processors of a computing system are configured to perform entropy coding, wherein, according to the Context-Sensitive Binary Arithmetic Codec (“CABAC”), symbols making up quantized residual coefficients are coded by mappings to binary strings (subsequently “bins”), which can be transmitted in an output bitstream at a compressed bitrate. The symbols of the quantized residual coefficients which are coded include absolute values of the residual coefficients (these absolute values being subsequently referred to as “residual coefficient levels”).

Thus, the entropy coder configures one or more processors of a computing system to code residual coefficient levels of a block; bypass coding of residual coefficient signs and record the residual coefficient signs with the coded block; record coding parameter sets such as coding mode, a mode of intra prediction or a mode of inter prediction, and motion information coded in syntax structures of a coded block (such as a picture parameter set (“PPS”) found in a picture header, as well as a sequence parameter set (“SPS”) found in a sequence of multiple pictures); and output the coded block.

A VVC and later standard encoder configures one or more processors of a computing system to output a coded picture, made up of coded blocks from the entropy coder 124. The coded picture is output to a transmission buffer, where it is ultimately packed into a bitstream for output from the VVC and later standard encoder. The bitstream is written by one or more processors of a computing system to a non-transient or non-transitory computer-readable storage medium of the computing system, for transmission.

In a decoding process 150, a VVC and later standard decoder configures one or more processors of a computing system to receive, as input, one or more coded pictures from a bitstream.

A VVC and later standard decoder implements an entropy decoder 152. One or more processors of a computing system are configured to perform entropy decoding, wherein, according to CABAC, bins are decoded by reversing the mappings of symbols to bins, thereby recovering the entropy-coded quantized residual coefficients. The entropy decoder 152 outputs the quantized residual coefficients, outputs the coding-bypassed residual coefficient signs, and also outputs the syntax structures such as a PPS and a SPS.

A VVC and later standard decoder further implements an inverse quantization 154 and an inverse transform 156. One or more processors of a computing system are configured to perform an inverse quantization operation and an inverse transform operation on the decoded quantized residual coefficients, by matrix arithmetic operations which are the inverse of the quantization operation and transform operation as described above. The inverse quantization operation and the inverse transform operation yield a reconstructed residual.

Furthermore, based on coding parameter sets recorded in syntax structures such as PPS and a SPS by the entropy coder 124 (or, alternatively, received by out-of-band transmission or coded into the decoder), and a coding mode included in the coding parameter sets, the VVC and later standard decoder determines whether to apply intra prediction 156 (i.e., spatial prediction) or to apply motion compensated prediction 158 (i.e., temporal prediction) to the reconstructed residual.

In the event that the coding parameter sets specify intra prediction, the VVC and later standard decoder configures one or more processors of a computing system to perform intra prediction 158 using prediction information specified in the coding parameter sets. The intra prediction 158 thereby generates a prediction signal.

In the event that the coding parameter sets specify inter prediction, the VVC and later standard decoder configures one or more processors of a computing system to perform motion compensated prediction 160 using a reference picture from a DPB 200. The motion compensated prediction 160 thereby generates a prediction signal.

A VVC and later standard decoder further implements an adder 162. The adder 162 configures one or more processors of a computing system to perform an addition operation on the reconstructed residuals and the prediction signal, thereby outputting a reconstructed block.

A VVC and later standard decoder further implements a loop filter 164. One or more processors of a computing system are configured to apply a loop filter, such as a deblocking filter, a SAO filter, and ALF to a reconstructed block, outputting a filtered reconstructed block.

A VVC and later standard decoder further configures one or more processors of a computing system to output a filtered reconstructed block to the DPB 200. As described above, a DPB 200 stores reconstructed pictures which are used by one or more processors of a computing system as reference pictures in coding pictures other than the current picture, as described above with reference to motion compensated prediction.

A VVC and later standard decoder further configures one or more processors of a computing system to output reconstructed pictures from the DPB to a user-viewable display of a computing system, such as a television display, a personal computing monitor, a smartphone display, or a tablet display.

Therefore, as illustrated by an encoding process 100 and a decoding process 150 as described above, a VVC and later standard encoder and a VVC and later standard decoder each implements motion prediction coding in accordance with VVC and later standard specifications. A VVC and later standard encoder and a VVC and later standard decoder each configures one or more processors of a computing system to generate a reconstructed picture based on a previous reconstructed picture of a DPB according to motion compensated prediction as described by VVC and later standards, wherein the previous reconstructed picture serves as a reference picture in motion compensated prediction as described herein.

VVC and later standards further provide that blocks and sub-blocks of a picture can further be partitioned according to geometric partitioning for inter prediction. Square or non-square blocks and sub-blocks of size having dimensions of at least 8 luma samples to each side can be partitioned according to geometric partitioning. A partitioning mode of a block or sub-block according to geometric partitioning can be indicated by a straight partitioning line spanning a first coordinate of a first side of the block or sub-block and a second coordinate of a second side of the block.

Based on the position of the first coordinate and the position of the second coordinate, as well as orientation of the first side and orientation of the second side, an angle of the partitioning line as drawn from the first coordinate to the second coordinate, and a distance of the partitioning line as spanning the first coordinate and the second coordinate, are characterized. The angle of the partitioning line and the distance of the partitioning line can further classify the partitioning mode as one of multiple template partitioning modes which can be specified according to implementations of geometric partitioning.

Geometric partitioning modes (“GPMs”) are signaled using a CU-level flag as one kind of merge mode among other possible merge modes including the regular merge mode, merge with motion difference (“MMVD”) mode, combined inter-intra prediction (“CIIP”) mode and the sub-block merge mode. In total, 64 partitions are supported by geometric partitioning mode for each possible CU size, excluding 8×64 and 64×8.

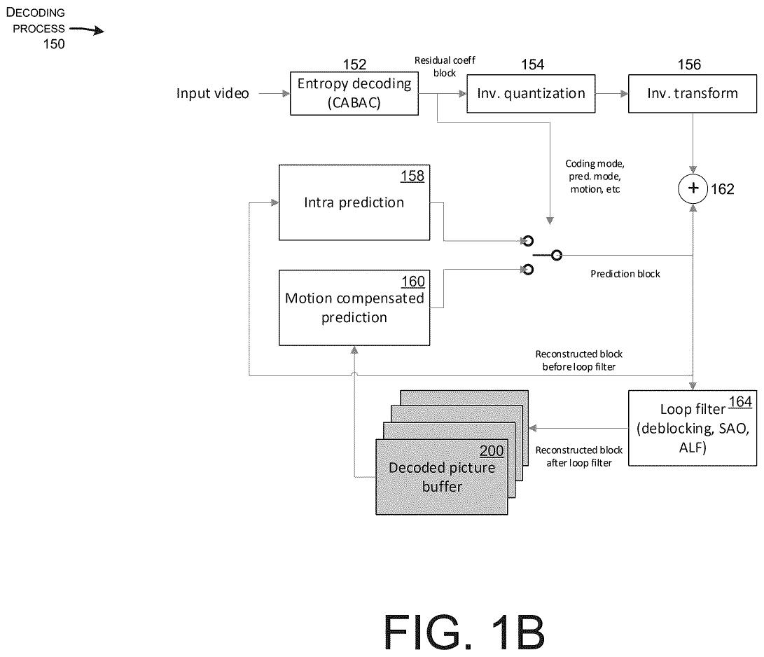

According to GPM motion prediction, a CU is geometrically partitioned, i.e., split into two parts by a geometrically located straight line. FIG. 2 illustrates classifications of GPM coded CUs by their respective angles. For each classification, the splitting line always has the same angle but can be at various different coordinates, where each classification is illustrated showing, by way of example, three among many possible coordinates.

The location of the splitting line is mathematically derived from the angle and offset parameters of a specific partition. Each of two partitions of a GPM coded coding block is inter-predicted using its own motion. A partition of a GPM coded block is also called a GPM partition.

To derive the motion of each partition of a GPM coded coding block, a GPM merge candidate list with uni-prediction candidate is constructed. First, MV candidates for list 0 and list 1 are derived directly from a regular merge candidate list and interleaved. List 0 candidates are higher priority candidates than list 1 candidates. A pruning method with an adaptive threshold based on the current coding block size is applied to these interleaved list 0 and list 1 MV candidates to remove redundant or similar MV candidates. Then, further list 0 and list 1 candidates are derived from the regular merge candidate list, but list 1 MV candidates are higher priority than list 0 MV candidates. The same pruning method with the same adaptive threshold is then applied once more to remove redundant MV candidates. Finally, Zero MV candidates are inserted as padding until the GPM merge candidate list is full. To determine the motion candidate for the two partitions, two merge indices of the used motion candidates are signaled, one for each partition.

According to GPM motion prediction for a current CU, a geometric partition index indicating the partition mode of the geometric partition (angle and offset), and two merge indices (one for each partition) are further signaled. A number indicating maximum size of a GPM merge candidate list is signaled explicitly in an SPS and specifies syntax binarization for GPM merge indices. After predicting each partition of a GPM coded coding block, the sample values along the geometric partition splitting line are adjusted using a blending processing with adaptive weights. This is the prediction signal for the whole coding block, and transform and quantization processes will be applied to the whole coding block as in other prediction modes.

According to VVC and later standards, a first motion vector (“Mv1”) of the first GPM partition, a second motion vector (“Mv2”) of the second GPM partition, and a combined motion vector (“Mv”) of Mv1 and Mv2 are stored in the motion field of a GPM coded coding block.

The stored motion vector type (“sType”) for each individual position in the motion field are determined by Equation 1 below:

$$s T y pe = abs ( motionIdx ) < 32 ? 2 : ( motionIdx \leq 0 ? ( 1 - partIdx ) : partIdx )$$

where motionIdx is equal to d(4x+2, 4y+2), which is recalculated from Equation 2 below.

$$d ( x , y ) = ( 2 x + 1 - w ) cos ( {φ}_{i} ) + ( 2 y + 1 - h ) sin ( {φ}_{i} ) - {ρ}_{j}$$

The partIdx depends on the angle index i.

If sType is 0 or 1, Mv0 or Mv1 are stored in the corresponding motion field. Otherwise, if sType is 2, a combined My from Mv0 and Mv2 are stored.

The combined My from Mv0 and Mv2 are generated based on first checking if Mv1 and Mv2 are from different reference picture lists (i.e., one from list 0 and the other from list 1). If so, Mv1 and Mv2 are combined to form the bi-predictive motion vectors. Otherwise, if Mv1 and Mv2 are from the same list, only uni-prediction motion vector Mv2 is stored.

According to VVC and later standards, after predicting each partition of a GPM coded coding block by reference to its own motion, blending is applied to the two prediction signals to derive samples around the geometric partition splitting line. The blending weight for each position of the coding block is derived based on the distance between individual position and the partition splitting line. Given indices for angle and offset of a geometric partition (represented as i, j), which depend on the signaled geometric partition index, the distance for a position (x, y) to the partition splitting line is derived according to Equation 2 above, and Equation 3, Equation 4, and Equation 5 below:

$$\begin{matrix}{ρ}_{j} = {ρ}_{x , j} cos ( {φ}_{i} ) + {ρ}_{y , j} sin ( {φ}_{i} ) \\ {ρ}_{x , j} = \{ \begin{matrix}0 & i \% 16 = 8 or ( i \%16 \neq 0 and h \geq w ) \\ \pm ( j \times w ) ≫ 2 & otherwise\end{matrix} \\ {ρ}_{y , j} = \{ \begin{matrix}\pm ( j \times w ) ≫ 2 & i \% 16 = 8 or ( i \%16 \neq 0 and h \geq w ) \\ 0 & otherwise\end{matrix}\end{matrix}$$

The signs of ρ_{x,j} and ρ_{y,j} depend on angle index i. The weights for each part of a geometric partition are derived according to Equation 6, Equation 7, and Equation 8 below:

$$\begin{matrix}wIdxL ( x , y ) = partIdx ? 32 + d ( x , y ) : 32 - d ( x , y ) \\ {w}_{0} ( x , y ) = \frac{Clip 3 ( 0 , 8 , ( wIdxL ( x , y ) + 4 ) ≫ 3 )}{8} \\ {w}_{1} ( x , y ) = 1 - {w}_{0} ( x , y )\end{matrix}$$

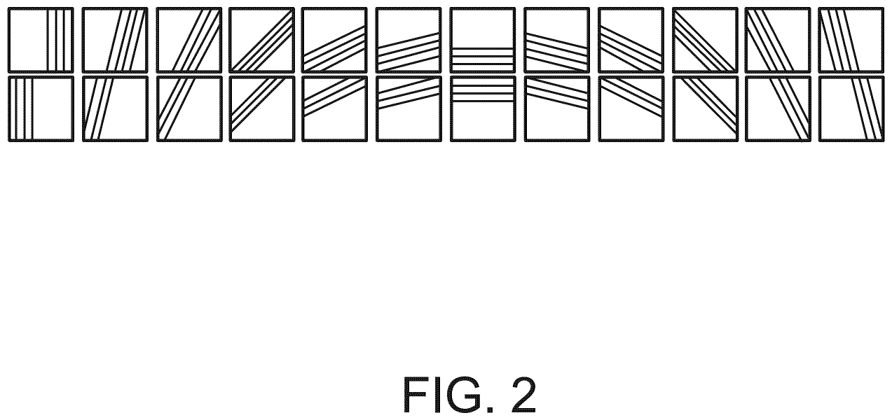

The variable partIdx depends on the angle index i. FIG. 3 illustrates an example blending weight w₀ derived for position (x, y).

According to VVC and later standards, final prediction samples are generated by blending the prediction of the two prediction signals using weighted average. Two integer blending matrices (W0 and W1) are used, where weights in the GPM blending matrices are derived from the ramp function based on the displacement d from a predicted sample position to the GPM splitting line. The blending area width τ is fixed to two (taking two samples on each side of the GPM partition splitting line).

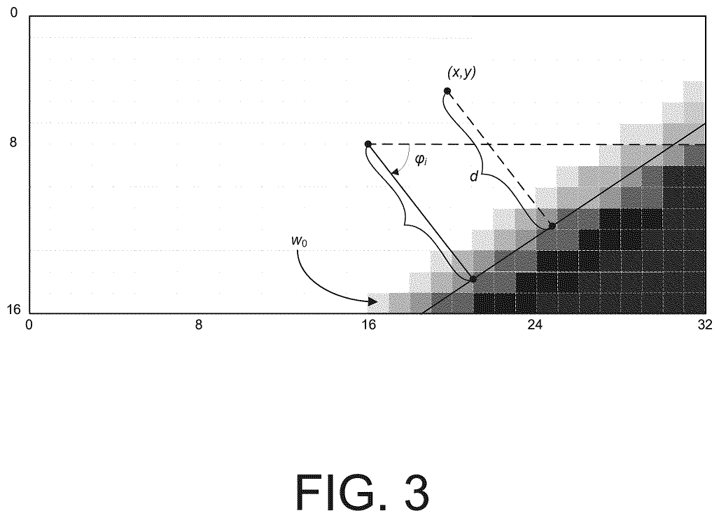

According to ECM, adaptive blending is further adopted for geometric partitioning. Specifically, aside from the existing blending area, additional blending area widths, i.e., quarter, half, double, and quadruple of the existing area width (τ/4, τ/2, 2τ, and 4τ), are added. FIG. 4 illustrates ramp functions for additional adoptive blending area widths based on the ramp function of an original blending area width.

The selected blending area width is signaled at CU-level from encoder to decoder. Furthermore, extended weighting precision is proposed: the maximum value of the weights is changed from 8 to 32 to accommodate the extended blending area widths.

Weights for a geometric partition and the prediction pixel are derived (based on A(x, y) and B(x, y) representing the prediction sample values at the coordinate (x, y) within the block referred by MV0 and MV1 prediction) by Equation 9 and Equation 10 below:

$$\begin{matrix}w ( x , y ) = \{ \begin{matrix}0 & d ( x , y ) \leq - {α}_{i} τ \\ \frac{32}{2 {α}_{i} τ} ( d ( x , y ) + {α}_{i} τ ) & - {α}_{i} τ \leq d ( x , y ) \leq {α}_{i} τ \\ 32 & d ( x , y ) \geq {α}_{i} τ\end{matrix} \\ p ( x , y ) = ( w ( x , y ) * A ( x , y ) + ( 32 - w ( x , y ) ) * B ( x , y ) + 16 ) ≫ 5\end{matrix}$$

In template matching (“TM”) based reordering for GPM split modes, template matching is performed by searching, in a predefined search range, based on an L-shaped template of the current block, for an L-shaped template in a reference picture having the least difference from the template of the current block (expressed by lowest cost according to a cost function). Given the motion information of the current GPM coded CU, the respective template matching cost values of GPM split modes are computed. Then, all GPM split modes are reordered in order of ascending TM cost values. Instead of signaling a GPM split mode, an index is signaled using Golomb-Rice code, the index locating a GPM split mode by the reordering.

GPM split mode reordering is a two-step process performed after the respective reference templates of the two partitions of a GPM coded coding block are generated. The first step is extending the geometric partition splitting line into the reference templates of the two partitions, resulting in 64 reference templates and computing the respective TM cost for each of the 64 reference templates. The second step is reordering GPM split modes based on their TM cost values in ascending order and marking the best 32 split modes as available split modes.

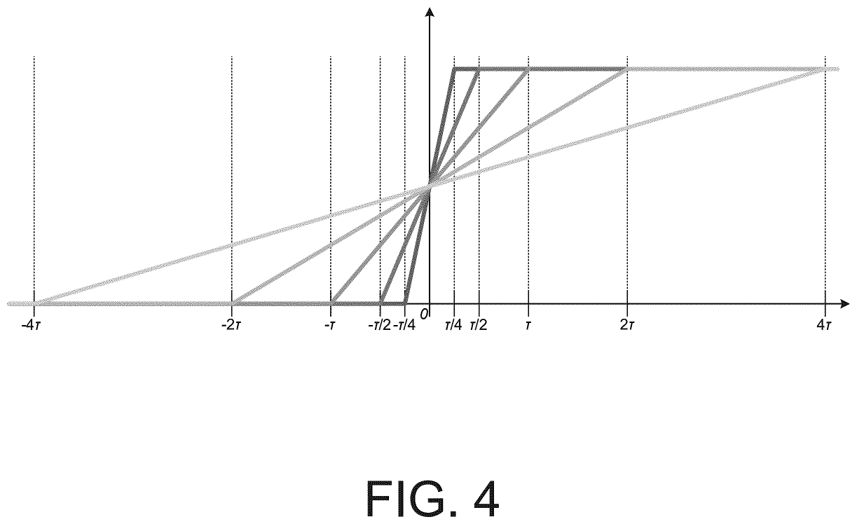

The splitting line over the template is extended from that of the current CU. FIG. 5 illustrates an example of extending a partition splitting line of a current CU. However, the GPM blending process is not applied in the template area across the splitting line. After reordering by ascending TM cost, an index is signaled using Golomb-Rice code (with divisor 4) to indicate the use of GPM split mode, as listed in Table 1 below:

Binary code

| Index | Prefix | Suffix |
|---|---|---|
| 0-3 | 0 | 00-11 |
| 4-7 | 10 | 00-11 |
| 8-11 | 110 | 00-11 |
| . . . | . . . | . . . |
| 28-31 | 1111 111 | 00-11 |

When GPM mode is enabled for a CU, a CU-level flag is signaled to indicate whether template matching is applied to both partitions of a GPM coded coding block. Motion information for each partition is refined using template matching. When template matching is chosen, a template is constructed using neighboring samples left of the current coding block, neighboring samples above the current coding block, or neighboring samples both left and above the current coding block according to partition angle, according to Table 2 below.

| | Partition angle | | | | | | | | | |
|---|---|---|---|---|---|---|---|---|---|---|
| | 0 | 2 | 3 | 4 | 5 | 8 | 11 | 12 | 13 | 14 |
| 1^{st} partition | A | A | A | A | L + A | L + A | L + A | L + A | A | A |
| 2^{nd} partition | L + A | L + A | L + A | L | L | L | L | L + A | L + A | L + A |
| | Partition angle | | | | | | | | | |
| | 16 | 18 | 19 | 20 | 21 | 24 | 27 | 28 | 29 | 30 |
| 1^{st} partition | A | A | A | A | L + A | L + A | L + A | L + A | A | A |
| 2^{nd} partition | L + A | L + A | L + A | L | L | L | L | L + A | L + A | L + A |

The motion is then refined by minimizing the difference between the template of the current coding block and the template of the reference picture using the same search pattern of merge mode with half-pel interpolation filter disabled.

One GPM coding block cannot use both MMVD and TM with GPM; GPM-MMVD and GPM-TM are mutually exclusive. This is enforced by signaling the GPM-MMVD syntax first in a bitstream, followed by the GPM-TM flag. When both GPM-MMVD control flags are equal to false (i.e., the GPM-MMVD are disabled for two partitions), the GPM-TM flag is signaled to indicate whether template matching is applied to the two partitions. Otherwise, when at least one GPM-MMVD flag is equal to true, the value of the GPM-TM flag is inferred to be false.

VVC and later standards extend GPM by applying motion vector refinement on top of the existing GPM uni-directional MVs. In a bitstream, a flag is first signaled for a GPM CU to specify whether motion vector refinement mode is applied. If motion vector refinement mode is applied, motion vector difference (“MVD”) can be signaled or not signaled for each partition of a GPM coded coding block. For each geometric partition for which MVD is signaled, after a GPM merge candidate is selected, the motion of the partition is further refined by the signaled MVD information. All other steps are kept the same as in GPM.

The MVD is signaled as a distance-direction pair, similarly to MMVD. There are nine candidate distances (¼-pel, ½-pel, 1-pel, 2-pel, 3-pel, 4-pel, 6-pel, 8-pel, 16-pel), and eight candidate directions (four horizontal/vertical directions and four diagonal directions) applicable in GPM-MMVD. In addition, when pic_fpel_mmvd_enabled_flag has a value of 1, the MVD is left shifted by 2 as in MMVD.

The GPM design in VVC and later standards relies on uni-predictive motion vectors to generate motion compensated prediction samples for each partition of a GPM coded coding block. ECM extends VVC and later standards to allow usage of bi-predictive motion vectors for GPM.

To support bi-predictive motion vectors, a GPM merge candidate list with bi-prediction candidates is constructed. When constructing the GPM merge candidate list, extraction of uni-predictive motion vectors from the initial merge candidate list is invoked only for small blocks 8×8, 16×8 and 8×16. For larger blocks, extraction is bypassed, so the initial merge candidate list (which may contain merged bi-predictive motion vectors, i.e., “bi-predictive merge candidates”) is the final GPM merge candidate list such that the bi-prediction motion candidates are contained in the candidate list. The generation of the initial merge candidate list is the same (i.e., the normal merge candidate list generation without any candidate reordering) except that when generating the initial merge candidate list for larger blocks (i.e., blocks with the extraction process bypassed), the motion vector difference threshold for controlling whether a candidate can be added into the merge candidate list is increased to one full sample distance.

Bi-directional optical flow (“BDOF”)-based motion vector refinement as in multi-pass Decoder-Side Motion Vector Refinement (“DMVR”) is applied when generating motion compensated prediction samples.

When GPM-MMVD is applied for a partition of a GPM coded coding block and its base motion vector is bi-predictive, for low-delay pictures, the signaled MVD is applied on top of the list 0 and list 1 motion vector as in the existing merge MMVD design. For non-low-delay pictures, the bi-predictive motion vector is converted to a uni-predictive motion vector, and then MVD is applied.

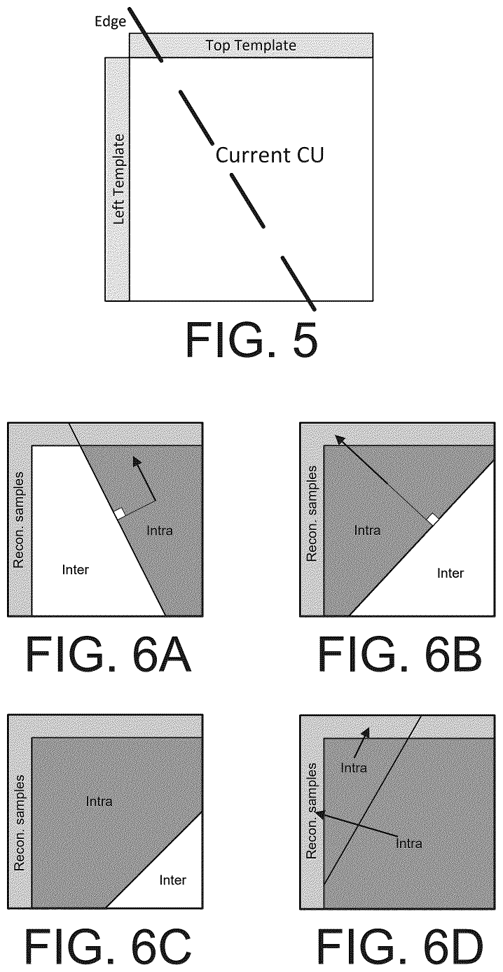

According to GPM with inter and intra prediction, final prediction samples are generated by weighting inter predicted samples and intra predicted samples for each GPM-separated region. Inter predicted samples are derived by inter GPM, while intra predicted samples are derived by an intra prediction mode (“IPM”) candidate list and an index signaled from the encoder. The IPM candidate list size is pre-defined as 3. FIGS. 6A through 6C illustrate respective examples of the available IPM candidates: parallel angular mode against the GPM block boundary (Parallel mode), perpendicular angular mode against the GPM block boundary (Perpendicular mode), and Planar mode.

Furthermore, FIG. 6D illustrates GPM with intra and intra prediction, restricted to reduce signaling overhead for IPMs so that the intra prediction circuit of the hardware decoder need not be expanded. In addition, a direct motion vector and IPM storage on the GPM-blending area are introduced to further improve coding performance.

According to decoder-side intra mode derivation (“DIMD”) and neighboring mode based IPM derivation, Parallel mode is registered first. Therefore, at most two IPM candidates derived from the DIMD method and/or the neighboring blocks can be registered if a same IPM candidate is not already in the IPM candidate list. As for the neighboring mode derivation, there are five positions for available neighboring blocks at most, but they are restricted by the angle of GPM block boundary, according to Table 3 below.

| | Angle of GPM | | | | | | | | | |
|---|---|---|---|---|---|---|---|---|---|---|
| | 0 | 2 | 3 | 4 | 5 | 8 | 11 | 12 | 13 | 14 |
| 1st partition | A | A | A | A | L + A | L + A | L + A | L + A | A | A |
| 2nd partition | L + A | L + A | L + A | L | L | L | L | L + A | L + A | L + A |
| | Partition angle | | | | | | | | | |
| | 16 | 18 | 19 | 20 | 21 | 24 | 27 | 28 | 29 | 30 |
| 1st partition | A | A | A | A | L + A | L + A | L + A | L + A | A | A |
| 2nd partition | L + A | L + A | L + A | L | L | L | L | L + A | L + A | L + A |

The GPM block boundaries are those already used for GPM with template matching (GPM-TM).

GPM with intra prediction (“GPM-intra”) can be combined with GPM-MMVD. Template-based intra mode derivation (“TIMD”) is applied for IPM candidates of GPM-intra to further improve coding performance. Parallel mode can be registered first, and then IPM candidates of TIMD, DIMD, and neighboring blocks can follow.

According to implicit GPM, two integer blending matrices (W0 and W1) are derived from the template (one line above and one column left of the current coding block). Blending matrices are modelled as an affine linear function of the sample positions (x, y) in the current CU by Equation 11 and Equation 12 below:

$$\begin{matrix}W 0 ( x , y ) = a . x + b . y + c \\ W 1 ( x , y ) = 1 - W 0 ( x , y )\end{matrix}$$

The parameters (a, b, c) are derived from the template of the reference pictures using the same solver (MSE minimization) as the one used for Convolutional cross-component model (“CCCM”), Gradient Linear Model (“GLM”) or Gradient and location based convolutional cross-component model (“GL-CCCM”). A list of GPM motion candidate pairs is constructed from the regular GPM merge candidates and re-ordered by template cost.

The GPM implicit mode is signaled by a CU-level flag (gpm_implicit_flag). If gpm_implicit_flag has a true value, a merge-idx is coded to signal the pair of GPM motion candidates to be used. If gpm_implicit_flag has a false value, the regular GPM syntax elements are signaled.

According to ECM, GPM is further extended to enable affine motion compensation (“AMC”). Therefore, a partition of a GPM coded coding block can be predicted by AMC inter-prediction, non-AMC inter-prediction or intra-prediction. In addition, a GPM partition predicted by AMC can be combined with the other GPM partition predicted by AMC inter-prediction, non-AMC inter-prediction, or intra-prediction.

When AMC inter-prediction is applied, a uni-prediction affine merge candidate list is constructed from the sub-block-based merge candidate list after discarding sub-TMVP candidates, similar to the uni-prediction merge candidate list construction for GPM in VVC and later standards. AMC inter-prediction is performed for a GPM partition using the control point motion vectors (“CPMVs”) of a merge candidate in the uni-prediction affine merge candidate list. The length of the uni-prediction affine merge candidate list is signaled in SPS. When ARMC is applicable, the uni-prediction affine merge candidate list is reordered by template cost.

A gpm_affine_flag is signaled for each partition of a GPM coded coding block to indicate whether AMC inter-prediction is applied for the GPM partition. A merge candidate index for the partition of a GPM coded coding block is signaled using individual arithmetic context models depending on whether AMC inter-prediction or non-AMC inter-prediction is applied. AMC inter-prediction is not allowed for GPM-MMVD and GPM-TM.

According to ECM, to further improve coding efficiency, a multi-pass decoder-side motion vector refinement is applied. In the first pass, bilateral matching (“BM”) is applied to the CU. In the second pass, BM is applied to each 16×16 sub-block within the CU. In the third pass, the MV in each 8×8 sub-block is refined by applying BDOF. The refined MVs are stored for both spatial and temporal motion vector prediction.

In the first pass, a refined MV is derived by applying BM to a CU. Similar to DMVR, in bi-prediction, a refined MV is searched near the two initial MVs (MV0 and MV1) in the reference picture lists 0 and 1. The refined MVs (MV0_pass1 and MV1_pass1) are derived near the initial MVs based on the minimum BM cost between the two reference blocks in list 0 and list 1.

BM-based MV refinement as performed in the first pass and the second pass is implemented by a local search to derive integer sample precision intDeltaMV. The local search applies a 3×3 square search pattern to loop through the search range [−sHor, sHor] in a horizontal direction and [−sVer, sVer] in a vertical direction, wherein, the values of sHor and sVer are determined by the block dimension, and the maximum value of sHor and sVer is 8 or other values.

The BM cost is calculated as: bilCost=mvDistanceCost+sadCost, wherein sadCost is the SAD between a list 0 predictor (i.e., a reference block from reference picture list 0) and a list 1 predictor (i.e., a reference block from reference picture list 1) on a search point and mvDistanceCost is based on intDeltaMV (i.e., the distance between the search point and the initial point). When the block size cbW (CB width, in pixels)×cbH (CB height, in pixels) is greater than 64, the mean-removed SAD (“MRSAD”) cost function is applied to remove the discrete cosine (“DC”) effect of distortion between reference blocks. When the bilCost at the center point of the 3×3 search pattern has the minimum cost, the intDeltaMV local search terminates. Otherwise, the current minimum cost search point is set as the new center point of the 3×3 search pattern and the search for the minimum cost continues, until the end of the search range is reached.

The existing fractional sample refinement is further applied to derive fractional MV refinement fracDeltaMV, and the final deltaMV is derived as intDeltaMV+fracDeltaMV. The refined MVs after the first pass are then respectively derived according to Equation 13 and Equation 14 below:

$$\begin{matrix}MV0\_pass1 = M {V}_{0} + deltaMV \\ MV1\_pass1 = M {V}_{1} - deltaMV\end{matrix}$$

In the second pass, a refined MV is derived by applying BM to a 16×16 grid sub-block. For each sub-block, a refined MV is searched near the two MVs (MV0_pass1 and MV1_pass1), obtained on the first pass, in the reference picture list 0 and 1. The refined MVs (MV0_pass2(sbIdx2) and MV1_pass2(sbIdx2)) are derived based on the minimum BM cost between the two reference sub-blocks in list 0 and list 1.

For each sub-block, BM-based MV refinement performs a full search to derive integer sample precision intDeltaMV(sbIdx2). The full search has a search range [−sHor, sHor] in a horizontal direction and [−sVer, sVer] in a vertical direction, wherein the values of sHor and sVer are determined by the block dimension, and the maximum value of sHor and sVer is 8 or other values.

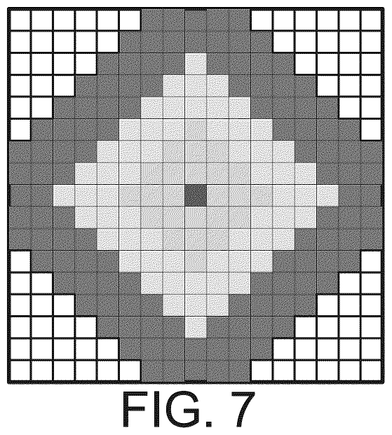

The BM cost can be calculated by applying a cost factor to the sum of absolute transformed differences (“SATD”) cost between two reference sub-blocks, as: bilCost=satdCost×costFactor. The search area (2×sHor+1)×(2×sVer+1) is divided up to 5 diamond-shaped search regions, as shown in FIG. 7. FIG. 7 illustrates a diagram of BM costs (each matching cost corresponding to a differently-shaded diamond-shaped search region) used in a second pass of a multi-pass decoder-side motion vector refinement. Each search region is assigned a costFactor, which is determined by the distance intDeltaMV(sbIdx2) between each search point and the starting MV, and each diamond-shaped region is processed in order starting from the center of the search area. In each region, the search points are processed in the raster scan order starting from the top left going to the bottom right corner of the region. When the minimum bilCost within the current search region is less than a threshold equal to sbW (sub-block width)×sbH (sub-block height), the int-pel full search terminates; otherwise, the int-pel full search continues to the next search region until all search points are examined. Additionally, if the difference between the previous minimum cost and the current minimum cost in the iteration is less than a threshold that is equal to the area of the block, the search terminates.

Furthermore, the BM costs as described above can also be calculated based on MRSAD instead of SAD, and can also be calculated based on mean-removed sum of absolute transformed differences (“MRSATD”) instead of SATD.

DMVR fractional sample refinement according to VVC and later standards is further applied to derive the final deltaMV(sbIdx2). The refined MVs at the second pass are then respectively derived according to Equation 15 and Equation 16 below:

$$\begin{matrix}MV0\_pass2 ( sbIdx 2 ) = MV0\_pass1 + deltaMV ( sbIdx 2 ) \\ MV1\_pass2 ( sbIdx 2 ) = MV1\_pass1 - deltaMV ( sbIdx 2 )\end{matrix}$$

In the third pass, a refined MV is derived by applying BDOF to an 8×8 grid sub-block. For each 8×8 sub-block, BDOF refinement is applied to derive scaled Vₓ and V_{y} without clipping starting from the refined MV of the parent sub-block of the second pass. The derived bioMv(Vₓ, V_{y}) is rounded to 1/16 sample precision and clipped between −32 and 32.

The refined MVs (MV0_pass3(sbIdx3) and MV1_pass3(sbIdx3)) at the third pass are respectively derived according to Equation 17 and Equation 18 below:

$$\begin{matrix}MV0\_pass3 ( sbIdx 3 ) = MV0\_pass2 ( sbIdx 2 ) + bioMv \\ MV1\_pass3 ( sbIdx 3 ) = MV0\_pass2 ( sbIdx 2 ) - bioMv\end{matrix}$$

According to the ECM extension of VVC and later standards, BDOF-based motion vector refinement as in the multi-pass DMVR is applied when generating motion compensated prediction samples, but the current GPM mode does not support a first-pass or second-pass DMVR as implemented according to multi-pass DMVR, leading to low inter-prediction accuracy.

Therefore, example embodiments of the present disclosure provide improvements to motion vector refinement for geometric partitioning, including application of first-pass and second-pass DMVR in GPM motion prediction.

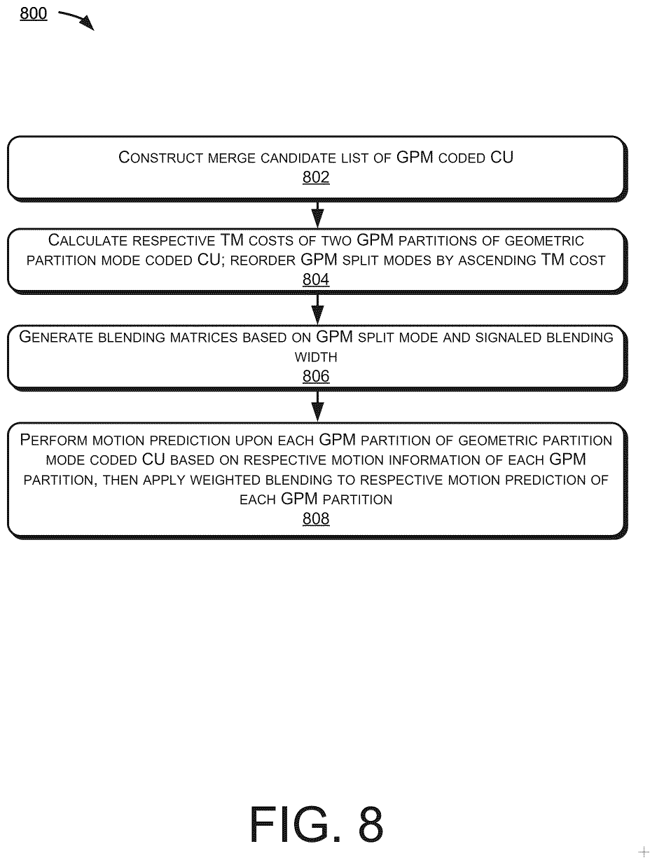

According to ECM extension of VVC and later standards, GPM is signaled using a CU-level flag as a type of merge mode. FIG. 8 illustrates a flowchart of a GPM motion prediction process 800 according to VVC and later standards extended by ECM.

At a step 802, a VVC and later standard encoder and a VVC and later standard decoder configure one or more processors of a computing system to construct a merge candidate list (which may contain merged bi-predictive motion vectors, i.e., “bi-predictive merge candidates”) of a GPM coded CU. A CU is GPM coded if any CU-level flag signaling a GPM mode has a true value.

At a step 804, the VVC and later standard encoder and the VVC and later standard decoder configure the one or more processors to calculate respective TM costs of two partitions of the GPM coded coding block, and reorder the GPM split modes by ascending TM cost. The encoder further configures the one or more processors to signal an index locating a GPM split mode by the reordering, and the decoder further configures the one or more processors to look up a GPM split mode in the reordering by the index.

At a step 806, the VVC and later standard encoder and the VVC and later standard decoder configure the one or more processors to generate blending matrices based on the GPM split mode and the signaled blending index which indicates the blending width.

At a step 808, the VVC and later standard encoder and the VVC and later standard decoder configure the one or more processors to perform motion prediction upon each partition of a GPM coded coding block based on respective motion information of each partition, then apply weighted blending to a respective motion prediction of each partition based on the blending matrices.

According to embodiments of the present disclosure, a first pass and a second pass of multi-pass DMVR are applied in GPM motion prediction, and a third pass of multi-pass DMVR may or may not be applied.

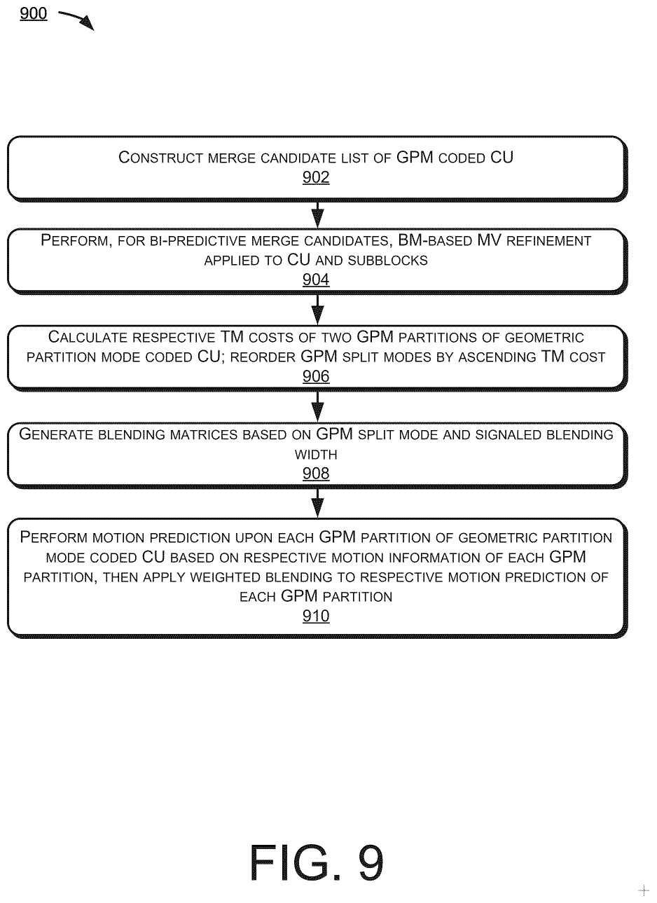

FIG. 9 illustrates a flowchart of a motion vector refinement process 900 for GPM motion prediction according to example embodiments of the present disclosure.

At a step 902, a VVC and later standard encoder and a VVC and later standard decoder configure one or more processors of a computing system to construct a merge candidate list of a GPM coded CU as in step 802 above.

At a step 904, according to one embodiment, the VVC and later standard encoder and the VVC and later standard decoder configure the one or more processors to perform, for merge candidates that meet DMVR conditions, BM-based MV refinement. As described above, BM-based MV refinement is implemented by applying BM to the CU in a first pass, and to each 16×16 sub-block within the CU in a second pass.

Merge candidates that meet DMVR conditions should be understood as bi-predictive merge candidates having one temporally forward reference picture and one temporally backward reference picture, where both the temporally forward and temporally backward reference pictures have a same resolution as the current picture.

Subsequently, one or more processors are configured to calculate respective TM costs and reorder GPM split modes at a step 906; generate blending matrices at a step 908; and perform motion prediction and apply weighted blending at a step 910 as described above with reference to FIG. 8.

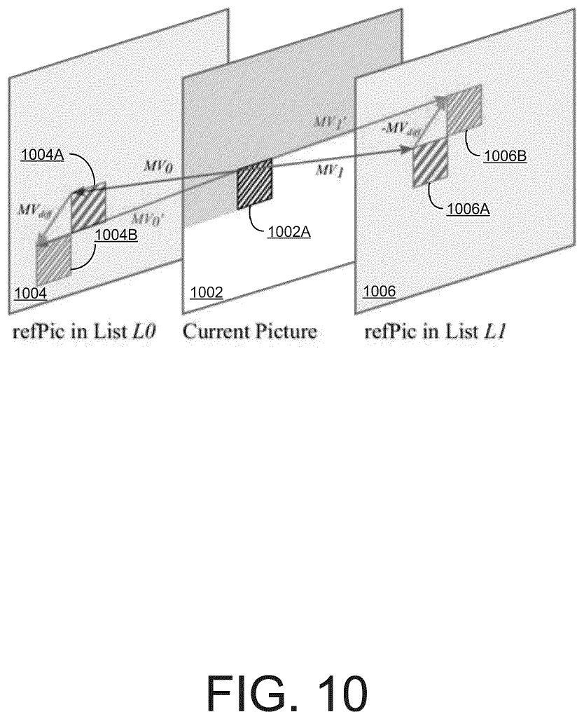

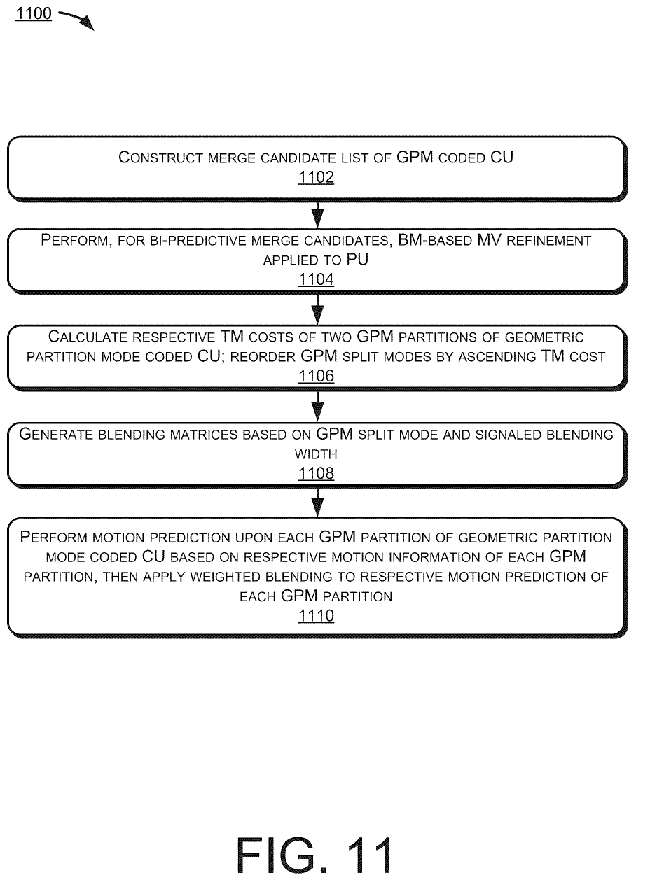

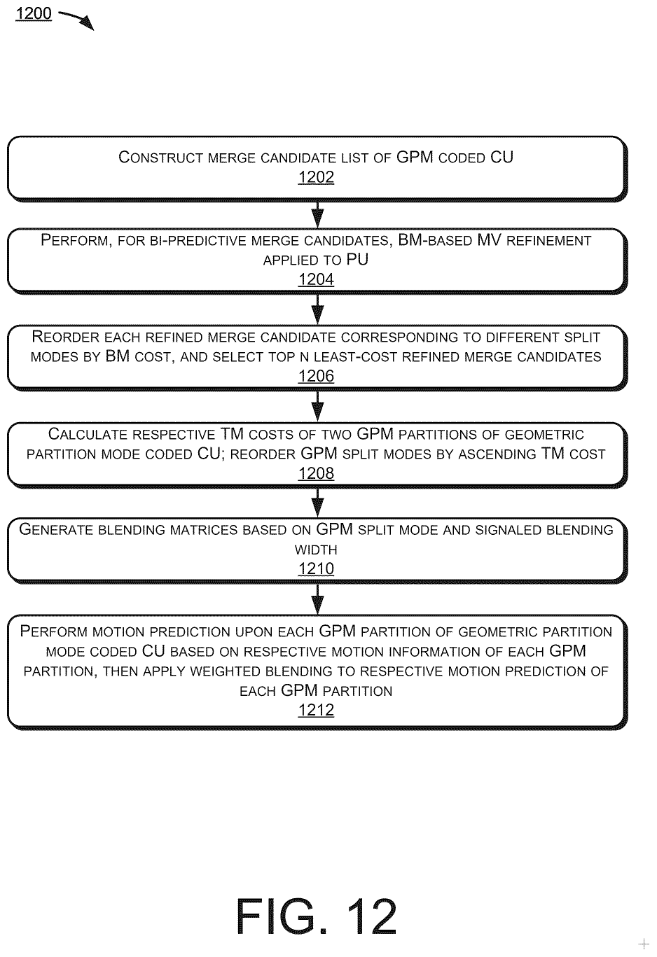

According to another embodiment, for merge candidates that meet DMVR conditions, BM-based MV refinement is implemented by applying BM to a PU as illustrated by FIG. 10. PU-level BM-based MV refinement can improve motion prediction accuracy for each partition, and MV refinement results can be further based on split modes as subsequently described with reference to FIGS. 11 and 12.

FIG. 10 illustrates a diagram of motion prediction performed upon a current picture 1002 according to bi-prediction, wherein offset blocks of reference pictures are used to calculate a refined motion vector that is in turn used to generate a bi-predicted signal. The current picture 1002 includes a current block 1002A. Two co-located reference pictures 1004 and 1006, one from reference list 0 in a first temporal direction, and one from reference list 1 in a second temporal direction, are illustrated in accordance with bi-prediction. Motion information of the current block 1002A refers to a co-located reference block 1004A of the co-located reference picture 1004, and refers to a co-located reference block 1006A of the co-located reference picture 1006. The co-located reference picture 1004 further includes an offset block 1004B near the co-located reference block 1004A, and the co-located reference picture 1006 further includes an offset block 1006B near the co-located reference block 1006A.

As illustrated in FIG. 10, a sum of absolute differences (“SAD”) between the reference block 1004A and the offset block 1004B, and a SAD between the reference block 1006A and the offset block 1006B, are calculated. The MV candidate with the lowest SAD is set as the refined MV and used to generate a bi-predicted signal.

FIG. 11 illustrates a flowchart of a motion vector refinement process 1100 for GPM motion prediction according to example embodiments of the present disclosure.

At a step 1102, a VVC and later standard encoder and a VVC and later standard decoder configure one or more processors of a computing system to construct a merge candidate list of a GPM coded CU as in step 802 above.

At a step 1104, the VVC and later standard encoder and the VVC and later standard decoder configure the one or more processors to perform, for merge candidates that meet DMVR conditions, BM-based MV refinement applied to a PU.

The BM-based MV refinement is implemented by searching for minimum BM cost between the two predictions of the reference partitions in list 0 and list 1, rather than between the two predictions of the reference blocks of list 0 and list 1 as described above. The shape and the size of the reference partitions depend on the split mode, and a weighted matrix can be applied to each reference block based on the split mode to yield respective reference partitions. Therefore, for a merge candidate that meets DMVR conditions, a MV refinement result varies depending on split modes of the reference partitioning lines. For example, given the 64 split modes supported in the current ECM draft, the same merge candidate, after undergoing PU-level BM-based MV refinement, yields 64×2 refined MV results.

At a step 1106, the VVC and later standard encoder and the VVC and later standard decoder configure the one or more processors to calculate respective TM costs and reorder GPM split modes as described above with reference to FIG. 8. To perform template matching for merge candidates that have undergone PU-level BM-based MV refinement, a corresponding number of reference templates under a particular split mode should also be obtained using the refined MVs corresponding to that split mode.

Subsequently, one or more processors are configured to generate blending matrices at a step 1108 and perform motion prediction and apply weighted blending at a step 1110 as described above with reference to FIG. 8.

MV refinement results of the same merge candidate under adjacent-indexed split modes may exhibit only minor differences, resulting in redundancy. Therefore, adjacent-indexed split modes can be merged (i.e., different partitions execute the same PU-level BM-based MV refinement) to yield fewer refined MVs and thereby reduce computational complexity. A same PU-level BM-based MV refinement is performed for the split modes which are similar to each other to yield a same refined MV. “Similar” split modes can include multiple split modes where partitioning lines have the same direction but different shift, or multiple modes where partitioning lines have similar directions. “Similar” split modes can also include multiple split modes where partitioning lines have the same shift but different directions.

FIG. 12 illustrates a flowchart of a motion vector refinement process 1200 for GPM motion prediction according to other example embodiments of the present disclosure.

At a step 1202, a VVC and later standard encoder and a VVC and later standard decoder configure one or more processors of a computing system to construct a merge candidate list of a GPM coded CU as in step 802 above.

At a step 1204, the VVC and later standard encoder and the VVC and later standard decoder configure the one or more processors to perform, for merge candidates that meet DMVR conditions, BM-based MV refinement applied to a PU.

At a step 1206, the VVC and later standard encoder and the VVC and later standard decoder configure the one or more processors to reorder each refined MV corresponding to different split modes by BM cost (calculated during the BM-based MV refinement of step 1204), and select the top n minimum-BM cost refined MVs.

For refined MVs that are not selected (not among the top n after reordering), the corresponding pre-refinement merge candidates are used instead when, subsequently, one or more processors are configured to generate blending matrices at a step 1208 and perform motion prediction and apply weighted blending at a step 1210 as described above with reference to FIG. 8.

Furthermore, encoder computational complexity can be reduced by using prediction samples generated through bilinear interpolation to calculate the SAD, thereby selecting the refined candidates for PU-level BM-based MV refinement.

Persons skilled in the art will appreciate that all of the above aspects of the present disclosure may be implemented concurrently in any combination thereof, and all aspects of the present disclosure may be implemented in combination as yet another embodiment of the present disclosure.

FIG. 13 illustrates an example system 1300 for implementing the processes and methods described above for implementing template matching for geometric partitioning.

The techniques and mechanisms described herein may be implemented by multiple instances of the system 1300 as well as by any other computing device, system, and/or environment. The system 1300 shown in FIG. 13 is only one example of a system and is not intended to suggest any limitation as to the scope of use or functionality of any computing device utilized to perform the processes and/or procedures described above. Other well-known computing devices, systems, environments and/or configurations that may be suitable for use with the embodiments include, but are not limited to, personal computers, server computers, hand-held or laptop devices, multiprocessor systems, microprocessor-based systems, set top boxes, game consoles, programmable consumer electronics, network PCs, minicomputers, mainframe computers, distributed computing environments that include any of the above systems or devices, implementations using field programmable gate arrays (“FPGAs”) and application specific integrated circuits (“ASICs”), and/or the like.

The system 1300 may include one or more processors 1302 and system memory 1304 communicatively coupled to the processor(s) 1302. The processor(s) 1302 may execute one or more modules and/or processes to cause the processor(s) 1302 to perform a variety of functions. In some embodiments, the processor(s) 1302 may include a central processing unit (“CPU”), a graphics processing unit (“GPU”), both CPU and GPU, or other processing units or components known in the art. Additionally, each of the processor(s) 1302 may possess its own local memory, which also may store program modules, program data, and/or one or more operating systems.

Depending on the exact configuration and type of the system 1300, the system memory 1304 may be volatile, such as RAM, non-volatile, such as ROM, flash memory, miniature hard drive, memory card, and the like, or some combination thereof. The system memory 1304 may include one or more computer-executable modules 1306 that are executable by the processor(s) 1302.

The modules 1306 may include, but are not limited to, one or more of an encoder 1308 and a decoder 1310.

The encoder 1308 may be a VVC and later standard encoder implementing any, some, or all aspects of example embodiments of the present disclosure as described above, and executable by the processor(s) 1302 to configure the processor(s) 1302 to perform operations as described above.

The decoder 1310 may be a VVC and later standard encoder implementing any, some, or all aspects of example embodiments of the present disclosure as described above, executable by the processor(s) 1302 to configure the processor(s) 1302 to perform operations as described above.

The system 1300 may additionally include an input/output (“I/O”) interface 1340 for receiving image source data and bitstream data, and for outputting reconstructed pictures into a reference picture buffer or DPB and/or a display buffer. The system 1300 may also include a communication module 1350 allowing the system 1300 to communicate with other devices (not shown) over a network (not shown). The network may include the Internet, wired media such as a wired network or direct-wired connections, and wireless media such as acoustic, radio frequency (“RF”), infrared, and other wireless media.

Some or all operations of the methods described above can be performed by execution of computer-readable instructions stored on a computer-readable storage medium 1330, as defined below. The term “computer-readable instructions” as used in the description and claims, include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof and the like.

The computer-readable storage media may include volatile memory (such as random-access memory (“RAM”)) and/or non-volatile memory (such as read-only memory (“ROM”), flash memory, etc.). The computer-readable storage media may also include additional removable storage and/or non-removable storage including, but not limited to, flash memory, magnetic storage, optical storage, and/or tape storage that may provide non-volatile storage of computer-readable instructions, data structures, program modules, and the like.

A non-transient or non-transitory computer-readable storage medium is an example of computer-readable media. Computer-readable media includes at least two types of computer-readable media, namely computer-readable storage media and communications media. Computer-readable storage media includes volatile and non-volatile, removable and non-removable media implemented in any process or technology for storage of information such as computer-readable instructions, data structures, program modules, or other data. Computer-readable storage media includes, but is not limited to, phase change memory (“PRAM”), static random-access memory (“SRAM”), dynamic random-access memory (“DRAM”), other types of random-access memory (“RAM”), read-only memory (“ROM”), electrically erasable programmable read-only memory (“EEPROM”), flash memory or other memory technology, compact disk read-only memory (“CD-ROM”), digital versatile disks (“DVD”) or other optical storage, magnetic cassettes, magnetic tape, magnetic disk storage or other magnetic storage devices, or any other non-transmission medium that can be used to store information for access by a computing device. In contrast, communication media may embody computer-readable instructions, data structures, program modules, or other data in a modulated data signal, such as a carrier wave, or other transmission mechanism. A computer-readable storage medium employed herein shall not be interpreted as a transitory signal itself, such as a radio wave or other free-propagating electromagnetic wave, electromagnetic waves propagating through a waveguide or other transmission medium (such as light pulses through a fiber optic cable), or electrical signals propagating through a wire.

The computer-readable instructions stored on one or more non-transient or non-transitory computer-readable storage media that, when executed by one or more processors, may perform operations described above with reference to FIGS. 1A-12. Generally, computer-readable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the processes.

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. A computing system to decode a video bitstream, comprising:
one or more processors, and
a computer-readable storage medium communicatively coupled to the one or more processors, the computer-readable storage medium storing computer-readable instructions executable by the one or more processors that, when executed by the one or more processors, perform associated operations comprising:
performing motion prediction upon a partition of a geometric partitioning mode (GPM)-coded coding block, based on motion information of the partition; and
applying weighted blending to a motion prediction of each partition of the GPM-coded coding block based on a blending matrix, wherein the blending matrix depends on a GPM split mode.

2. The computing system of claim 1, wherein performing motion prediction upon the partition of the GPM-coded coding block based on the motion information of the partition comprises:
decoding a GPM merge candidate index from a video bitstream;
determining a motion candidate from a GPM motion candidate list based on the GPM merge candidate index;
performing bilateral matching (BM)-based motion refinement on the motion candidate to generate refined motion; and
performing motion prediction upon the partition of the GPM-coded coding block based on refined motion of the partition.

3. The computing system of claim 2, wherein performing BM-based motion refinement comprises:
applying BM-based motion refinement to the partition of the GPM-coded coding block to yield a refined motion of the partition; and
applying BM-based motion refinement to each sub-block within the partition of the GPM-coded coding block to yield a refined motion of the sub-block.

4. The computing system of claim 2, wherein applying BM-based motion refinement comprises searching, for a first reference block of a reference picture in reference picture list 0 and a second reference block of a reference picture in reference list 1, for a minimum BM cost corresponding to the first reference block and the second reference block.

5. The computing system of claim 4, wherein the BM cost is calculated based on a difference between a first reference partition and a second reference partition, wherein the first reference partition is a subset of the first reference block and the second reference partition is a subset of the second reference block.

6. The computing system of claim 4, wherein the BM cost is calculated based on a difference between a first reference partition and a second reference partition, wherein the first reference partition comprises a weighted matrix applied on the first reference block and the second reference partition comprises the weighted matrix applied on the second reference block, wherein the weighted matrix depends on the GPM split mode.

7. The computing system of claim 2, wherein BM-based motion refinement is performed to the partition of the GPM-coded coding block corresponding to a GPM split mode to yield a refined motion of the partition corresponding to the GPM split mode.

8. The computing system of claim 2, wherein a same BM-based motion refinement is performed for a plurality of similar GPM split modes to yield a same refined motion corresponding to the plurality of similar GPM split modes.

9. The computing system of claim 8, wherein the plurality of similar GPM split modes comprises GPM split modes where partitioning lines have a same direction but different shifts.

10. The computing system of claim 8, wherein a plurality of similar GPM split modes comprises GPM split modes where partitioning lines have similar directions.

11. The computing system of claim 8, wherein a plurality of similar GPM split modes comprises GPM split modes where partitioning lines have a same shift but different directions.

12. The computing system of claim 2, wherein the operations further comprise:
reordering the refined motion of the partition corresponding to each GPM split mode by BM cost; and
determining a refined motion of the partition;
wherein performing motion prediction upon the partition is based on a respectively determined refined motion.

13. The computing system of claim 2, wherein the BM cost is based on a sum of absolute differences between bilinear interpolated prediction samples.

14. The computing system of claim 1, wherein the operations further comprise decoding a first index indicating the GPM split mode and a second index indicating motion of the partition from the bitstream.

15. A computing system to encode a video sequence to a bitstream, comprising:
one or more processors, and
a computer-readable storage medium communicatively coupled to the one or more processors, the computer-readable storage medium storing computer-readable instructions executable by the one or more processors that, when executed by the one or more processors, perform associated operations comprising:
performing motion prediction upon a partition of a geometric partitioning mode (GPM)-coded coding block, based on motion information of each partition; and
applying weighted blending to a motion prediction of each partition of the GPM-coded coding block based on a blending matrix, wherein the blending matrix depends on a split mode.

16. The computing system of claim 15, wherein performing motion prediction upon each partition of the GPM-coded coding block based on the respective motion information of each partition comprises:
determining a motion candidate from a GPM motion candidate list based on a GPM merge candidate index;
performing bilateral matching (BM)-based motion refinement on the motion candidate to generate refined motion; and
performing motion prediction upon the partition of the GPM-coded coding block based on refined motion of the partition; and
signaling the GPM merge candidate index in a video bitstream.

17. The computing system of claim 16, wherein performing BM-based motion refinement comprises:
applying BM-based motion refinement to the partition of the GPM-coded coding block to yield a refined motion for the partition; and
applying BM-based motion refinement to each sub-block within the partition of the GPM-coded coding block to yield a refined motion of each sub-block.

18. The computing system of claim 16, wherein applying BM-based motion refinement comprises searching, for a first reference block of a reference picture in reference picture list 0 and a second reference block of a reference picture in reference list 1, for a minimum BM cost corresponding to the first reference block and the second reference block.

19. The computing system of claim 16, wherein BM-based motion refinement is performed to a partition of the GPM-coded coding block corresponding to a split mode to yield a refined motion of the partition corresponding to the split mode.

20. A method of storing a bitstream associated with a video sequence, the method comprising:
generating a bitstream comprising:
an index locating a geometric partitioning mode (“GPM”) split mode to split a GPM-coded coding block into two partitions;
and
storing the bitstream in a non-transitory computer-readable storage medium.
